(19) United States
(12) Patent Application Publication
(10) Pub. No.: US 2005/0175741 A1
(43) Pub. Date: Aug. 11, 2005

(54) Packaging for foodstuff comprising a displaceable bottom body or lid part

(76) Inventor: Antonius Aloyisius Michael Maria Reinders, Rijksstraatweg (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 10/506,899

(22) PCT Filed: Mar. 4, 2003
(86) PCT No.: PCT/NL03/00164

(30) Foreign Application Priority Data
Mar. 6, 2002 (NL) 1020118
Jun. 23, 2002 (NL) 1020926
Sep. 22, 2002 (NL) 1021508

(51) Int. Cl. C12C 1/027

(52) U.S. Cl. 426/106

(57) ABSTRACT

The invention relates to a packaging for foodstuffs, comprising: a receptacle (10) having a displaceable part (16) which forms part of the bottom, the body part or the lid, which part is connected to the remaining peripheral part (16) of respectively the bottom, the body part or the lid by an elastically deformable coupling edge (17), such that the displaceable part is movable between a first position displaced to the outside and a second position displaced to the inside. The packaging has the feature that the displaceable part has a generally rectangular shape corresponding with the shape of said remaining part of the bottom, the body or the lid; the surface area of the displaceable part amounts to at least 50% of the total surface area of the bottom, the body or the lid; the displaceable part has bending stiffness.

The invention relates to a packaging for foodstuffs to be offered for sale, comprising:
an integral receptacle having on its top side a mouth opening and on its underside a bottom with an upright body connecting thereto and having at least one flat body part;
which mouth opening is bounded by a mouth rim which lies substantially in a flat plane and which, after filling of the receptacle with foodstuff and optionally a chosen gas or gas mixture, can co-act in hermetically sealing manner with a lid, for instance a foil connected by sealing to the mouth rim;
a generally flat displaceable part which forms part of the bottom, the body part or the lid and acts as displacer, which part is connected to the remaining peripheral part of respectively the bottom, the body part or the lid by an at least one-dimensionally elastically deformable coupling edge; and
optionally a filling with a gas serving as protective atmosphere, for instance a mixture of CO₂ and N₂ or CO₂ and O₂

Such a packaging is known from U.S. Pat. No. 3,426,939. The packaging known from this American patent comprises a round central bottom part which is connected to the rest of the bottom via a coupling edge with a generally truncated cone shape. The bottom can have a round, oval or generally rectangular form.

The drawback of the known packaging is that the displacement of said bottom part has only a relatively small influence on the effective volume of the container. Referred to as an example of application is the placing of foodstuff in heated state in a packaging and subsequent closure of the packaging. The packaging with its content then cools, whereby an underpressure is created in the packaging. The consequence hereof is that the ambient air, in particular the oxygen present therein, is given the opportunity after a time, depending on the type of packaging, to penetrate into the foodstuff. This shortens the possible shelf life, i.e. the time between the production phase and the moment of consumption of the foodstuff. In the known art the receptacle and the lid must moreover be able to withstand the pressure difference between the pressure of the outside air and the considerably lower pressure in the filled packaging.

With a view to the above it is an object of the invention, among others, to provide a packaging for foodstuffs which is embodied such that relatively low mechanical demands are made of the receptacle as well as the lid which can be used after filling to hermetically seal the container.

A further object of the invention is to provide a packaging which is embodied such that the shelf life can be prolonged substantially, even without the use of possible preservatives. Use can however be made of a protective atmosphere, for instance nitrogen gas, carbon dioxide or other gases or gas mixtures.

Yet another object of the invention is to provide a packaging which is compartmentalized, for instance for the purpose of offering for sale ready-to-eat meals consisting of different components. In the documented prior art, U.S. Pat. No. 3,426,939, it is generally not possible with such a packaging to obtain any substantial displacement, whereby the effect to be achieved is negligible. This is a result of the fact that the bottom is subdivided into individual bottom parts which are added to each compartment and which each have only a limited surface area. Of this already limited surface area a substantial part is taken up by the coupling edge which connects each displaceable relevant bottom part to the peripheral edge, i.e. the remaining part of the bottom part in question.

In respect of the above, the packaging has the feature according to the invention that
the displaceable part has a generally rectangular shape corresponding with the shape of said remaining part of the bottom, the body or the lid;
the surface area of the displaceable part amounts to at least 50% of the total surface area of the bottom, the body or the lid;
the displaceable part substantially has bending stiffness;
an elastically deformable zone is situated in each of the four corner zones of the coupling edge and over the whole periphery of the displaceable part;
this such that the displaceable part is movable between a first position displaced to the outside and a second position displaced to the inside.

A substantial advantage of the packaging according to the invention lies in the fact that a considerably larger part of the bottom, the body and/or the lid effectively takes part in the change of volume which is to be realized.

It is noted that the stated concept of “bending stiffness” in respect of the displaceable part should be understood to mean that the bending of this displaceable part occurring under the influence of a pressure difference causes a volume change in the packaging which is negligible compared to the effective volume change occurring because the displaceable part is displaced between respectively the first and the second position.

Because a longer shelf life can be realized with the invention, the invention also provides the possibility of an increased commercial potential. In respect of transport of the packagings with the invention, a greater delivery radius can for instance be realized, which can substantially increase the market potential according to the invention.

The invention is suitable for application with a displacer in the bottom, an upright wall part which forms part of the body and the lid. For instance in the case of a relatively flat, shallow packaging with a number of compartments, as in ready-to-eat meals, the lid in particular is the appropriate place for accommodation of the displacer according to the invention.

U.S. Pat. No. 5,546,731 relates to a container with a movable bottom part. The bottom part in question has a surface area in the order of magnitude of 20% of the total bottom surface area. This American patent further shows that the structure of the receptacle is such that the whole bottom is has relatively little bending stiffness and that in both extreme positions the receptacle does not therefore have a well-defined form. In the outward displaced first position for instance the receptacle cannot rest in stable manner on the bottom. Essentially there is no displacer part in this American patent, but rather a bottom with relatively little bending stiffness and enhanced by rib contours.

A specific embodiment of the packaging according to the invention has the feature that the displaceable part is situated in the bottom and that in the first position the receptacle can rest on the displaceable part of the bottom and in the second position can rest on the bottom edge.

An important particular embodiment of the packaging according to the invention has the feature that the deformable zone consists at least in said corner zones of at least two hinge lines. The hinge lines can extend parallel to each other but can also have a relation other than mutually parallel. What is essential is that the displaceable bottom part is movable relatively easily between the two stable positions, wherein particular attention must be paid to the relevant deformability in the corners. Use can for instance be made of a configuration in which from each of the four corners there extend two hinge lines extending at an angle in the direction of a hinge line connecting the coupling edge to the displaceable bottom part. Other configurations are also suitable.

In yet another embodiment the packaging has the special feature that the deformable zone comprises a rolling zone.

As the displaceable bottom part moves from the one extreme position to the other extreme position under the influence of a pressure difference inside and outside the hermetically closed packaging, the weakest point, in particular one of the four corner zones, will be the first to move inward, this then being followed by the other three corner zones until the whole bottom part has moved into the other position.

A specific embodiment of the packaging according to the invention has the feature that the hinge lines are corrugations protruding out of the local main plane of the receptacle. These corrugations can take a single or multiple form such that the coupling edge is connected pivotally to the displaceable bottom part and to the peripheral part of the bottom.

The packaging is preferably embodied such that the receptacle consists of plastic. Other materials are also suitable, for instance tin.

A specific embodiment has the feature that the receptacle is manufactured by thermoforming or vacuum-forming, for instance from a laminate. Such an embodiment is relatively inexpensive and allows manufacture with relatively small wall thicknesses. The nature of these techniques is however such that the wall thickness is not completely controllable and cannot be the same everywhere.

To the extent that a controllable wall thickness is desired, a variant can have the special feature that the container is manufactured by injection moulding.

In a particular embodiment the packaging has the feature that the receptacle consists substantially of foam material. There are different methods of manufacturing a receptacle from foam material, for instance injection moulding with a foaming plastic.

Recommended however is an embodiment wherein the receptacle is formed from a strip of foam material.

This embodiment can have the special feature that the strip of foam material is manufactured by extrusion and optional sizing.

For the purpose of an additional mechanical strength and/or to obtain a good sealing for a gas component present in the packaging, the packaging can have the special feature that by a laminating operation following the extrusion there is arranged on at least one side a foil layer, for instance an oxygen-barrier foil. It will be apparent that the foil layer can also be arranged on both sides.

In another embodiment the packaging has the feature that the strip of foam material is not fully foamed and that by supplying heat to the mould cavity of a die an additional foaming occurs, whereby a desired, for instance uniform wall thickness can be obtained. The advantage of this embodiment can be based on the fact that within certain limits any desired wall thickness can be realized, and that the wall thickness can for instance be the same all over. This is not possible when forming takes place from a strip of fully foamed foam material. This may give the user of such a simple receptacle the impression that the receptacle is of lesser quality.

In another embodiment the packaging can have the special feature that the hinge lines are formed by ribs present in the mould cavities of a die.

This latter variant is preferably embodied such that the ribs are situated on a releasable insert which has to be positioned in the mould cavity of the die. The advantage of this embodiment is that the pattern of lines can be modified easily in this manner when a determined die is being used, so that changing of the desired products in a line can take place rapidly.

In an alternative the packaging, wherein the receptacle consists substantially of foam material, can have the feature that the hinge lines are formed by pressing against a formed receptacle an optionally heated stamp having ribs corresponding with the hinge lines. By making use of the described stamp, the receptacle can be provided very simply with the hinge lines. Just as when use is made of a strip of foam material to form the receptacle, high production speeds can be realized in this manner.

In yet another embodiment the packaging has the special feature that the receptacle is formed from a blank consisting substantially of cardboard.

This latter embodiment preferably has the special feature that the blank is provided with a foil, for instance an oxygen-barrier foil, on at least the side of the blank later forming the inside of the receptacle.

A simple embodiment has the special feature that the receptacle is formed from the blank by a mould with a forming surface and corresponding stamp. It is noted that, by making use of a mould with a forming surface and a correspondingly shaped stamp, the corner zones which mutually connect the four upright walls are crumpled together more or less uncontrollably. This does not always leave the impression of the highest quality.

A slightly more expensive embodiment which can however give the impression of very good quality has the special feature that the receptacle is formed by first removing the four corner zones from the blank and subsequently folding the walls upward and adhering the corner edges of these walls sealingly to each other in mutually overlapping relation.

This latter variant can preferably be embodied such that the blank is provided on both sides with a foil, and the sealing adhesion is brought about by a welding operation.

In yet another embodiment the packaging according to the invention has the feature that the receptacle is formed from a blank consisting substantially of cardboard. Such a technique is per se known and is used to manufacture packagings for eggs.

In yet another variant, the packaging according to the invention has the feature that the receptacle consists of aluminium, for instance with a thickness in the order of magnitude of 60 μm.

Examples of foodstuffs for filling the packages according to the invention are potatoes, in particular peeled potatoes, and fish. Potatoes and fish have the property of absorbing gas. During the filling process a protective atmosphere is introduced into the container, consisting for instance of a mixture of carbon dioxide and nitrogen. Due to said absorption an underpressure is gradually created after hermetic closure of the container. In this embodiment the movable bottom part compensates the resulting pressure difference substantially by moving from its outward displaced position to its inward displaced position.

The packaging according to the invention thus continues to substantially retain its nominal shape under the given varying conditions and the foil, in the case of a foil cover, is mechanically loaded to only negligible extent. In the first situation the receptacle rests on the central bottom part and in the second situation the container rests on the bottom peripheral edge.

A specific embodiment has the special feature that both the first position and the second position of the displaceable part are stable, and the configuration thus possesses a bistable character. In this embodiment the displaceable part can be displaced in clicking manner from the one position to the other.

A specific embodiment of the packaging according to the invention has the special feature that the packaging is intended for potatoes and/or fish or products based thereon, that the gas mixture contains CO₂ and N₂ and that the ratio of these gas components amounts to 70:30, preferably 80:20 and still more preferably 90:10.

When a ratio of 70:30 is used more gas is present in the packaging according to the invention than in the prior art packaging. When another gas composition is used, such as 80:20, not only is there physically more gas available in the packaging but there is also physically more CO₂ present which can provide the preservative action. The prediction that a ratio in the order of 90:10 would provide a still further improvement in the shelf life has also been proven experimentally.

By way of illustration:

| | | | |
|---|---|---|---|
| CO₂:N₂ = | 70:30 | best before | 7 days |
| | 80:20 | best before | 9 days |
| | 90:10 | best before | 12 days |

The receptacles available on the market at the moment are not able to withstand the underpressure created in the packaging. The structure according to the invention is however capable of doing this.

Another composition of the protective atmosphere is a mixture of CO₂ and O₂, optionally supplemented with the inert N₂, whereby less problems are encountered from a “pseudo-vacuum”, this as used in the meat industry. A usual ratio of these gas components CO₂:N₂ is 50:50. The dosing of oxygen is used here so as to not allow discolouration of the meat. It is known that addition of additional CO₂ increases the shelf life. It is conceivable however that this will cause some discolouration. Following the above reasoning in respect of CO₂ and N₂, it could be supposed that without changing the gas composition more CO₂ is present in the packaging according to the invention for preservative purposes. If this extra CO₂ is absorbed, there then remains relatively more O₂ to prevent discolouration. This means that the gas composition can be adjusted in the sense of increasing the relative amount of CO₂ without there having to be any fear of discolouration.

In respect of the foregoing, the invention also provides a packaging which has the feature that the packaging is intended for meat or products based thereon, that the gas mixture contains CO₂ and O₂ and that the ratio of these components is chosen to achieve an optimum in respect of discolouration of the packed foodstuff and the shelf life.

When a displacer part is used in the bottom, an additional advantage results when the invention is applied. In meat packages an absorbent cloth is often used to absorb meat juices. In the packaging according to the invention of the described type this is not necessary, since the juice leaving the meat can collect in the “moat” all around, i.e. the peripheral part of the bottom. An annular absorbent cloth can optionally be laid therein.

As already discussed above, particular attention has been paid in the invention to fresh products such as potatoes and meat. Fish should also be included herein. In such packages there is generally a receptacle with only one compartment. In another type of product, namely ready-to-eat meals, there is a plurality of compartments in one receptacle. The displaceable part acting as displacer can in principle be present in the bottom, the body, i.e. a wall part forming part thereof, the lid or in combinations thereof. Decisive are the available space and the possibility of realizing a desired volume change.

Finally, the invention relates to a packaging intended for frozen goods, for instance ice cream or deep-frozen products, wherein the protective atmosphere is absent and wherein after removal of the lid the frozen product can be released from the receptacle by pressing the displaceable part inward.

The invention will now be elucidated with reference to the annexed drawings. Herein:

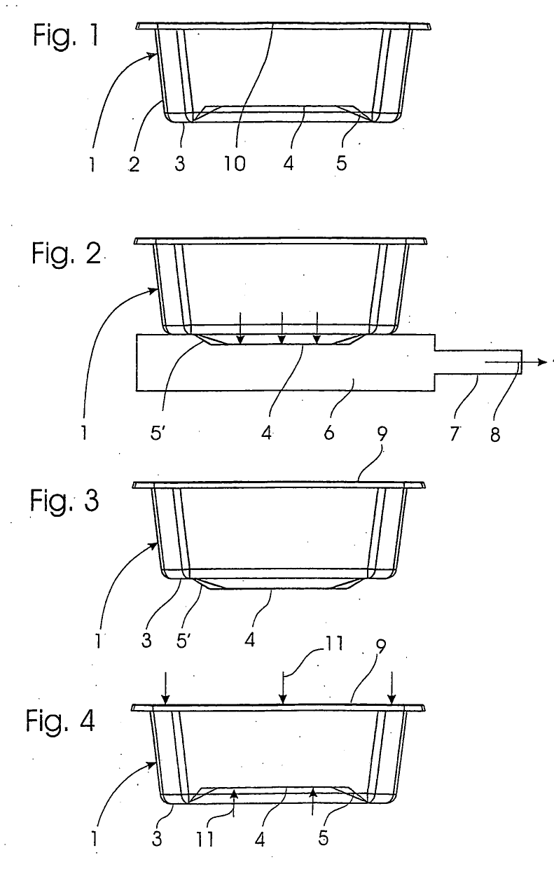

FIG. 1 shows a schematic cross-section through a container according to the invention;

FIG. 2 shows the container of FIG. 1 during drawing of the bottom downward and filling with foodstuff;

FIG. 3 shows the filled and closed container;

FIG. 4 shows the container after some time has elapsed;

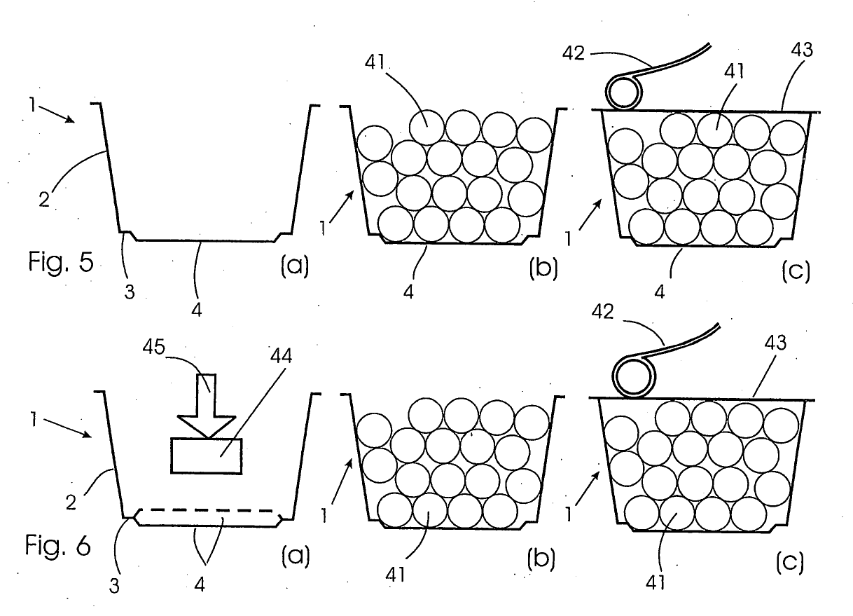

FIGS. 5, 6, 7 and 8 show in the respective phases (a), (b) and (c) the supply, filling with cold or heated foodstuff and sealing of a container in accordance with four different methods according to the invention;

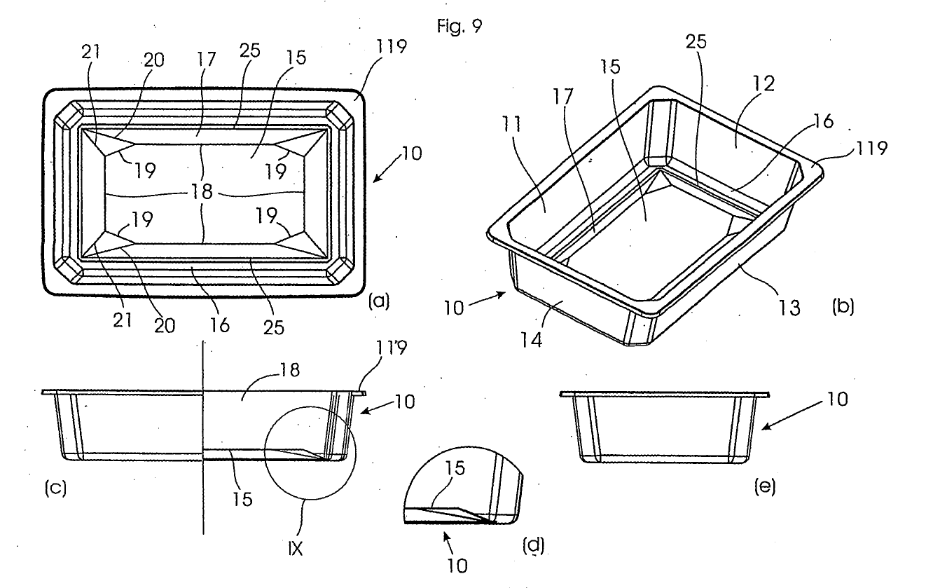

FIG. 9a is a top view of a container according to the invention;

FIG. 9b is a perspective view of the container, which view shows that the container of FIG. 9 is in a situation where the displaceable bottom part is in its upper stable position;

FIG. 9c is a partial side view and a partial cross-section of the container;

FIG. 9d shows the detail IV of FIG. 9c and FIG. 9e shows another side view of the container;

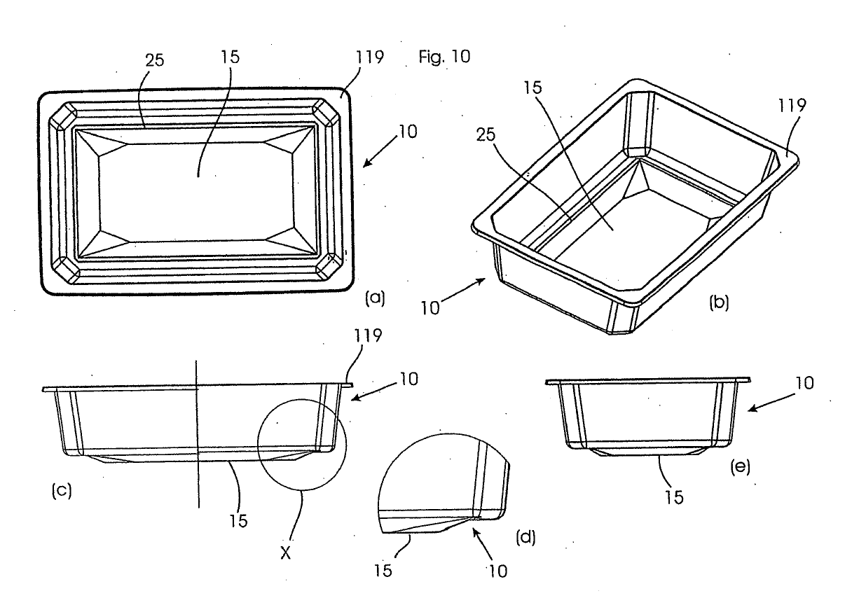

FIG. 10a, 10b, 10c, 10d show views corresponding with FIG. 9a, 9b, 9c, 9d, 9e of the container in the situation where the displaceable bottom part is situated in its lower stable position, and wherein FIG. 10d corresponds with the detail X of FIG. 10c;

FIG. 11a shows a corner part of an alternative container with a rolling edge;

FIG. 11b shows a cross-section through the container in the situation shown in FIG. 11a, in which the displaceable bottom part is situated in its lower position;

FIG. 11c shows a cross-section corresponding with FIG. 11b in the situation in which the displaceable bottom part is situated in its upper position;

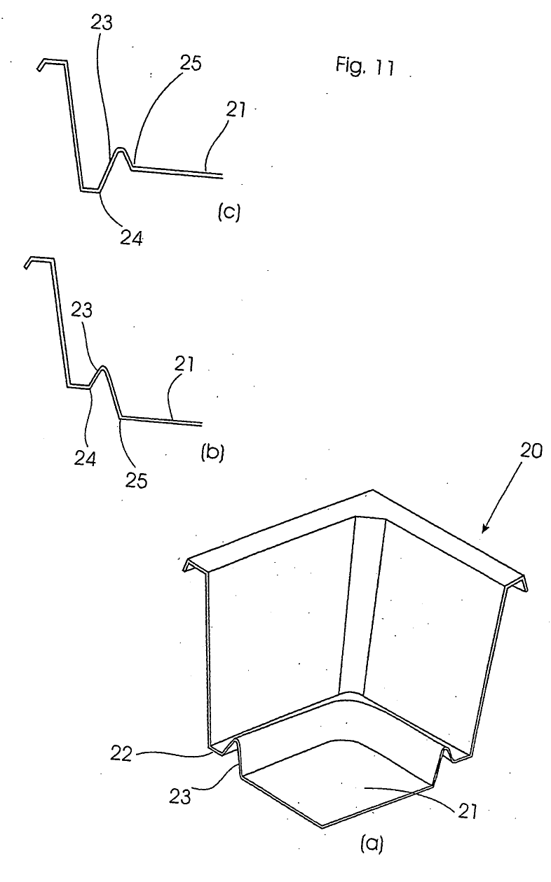

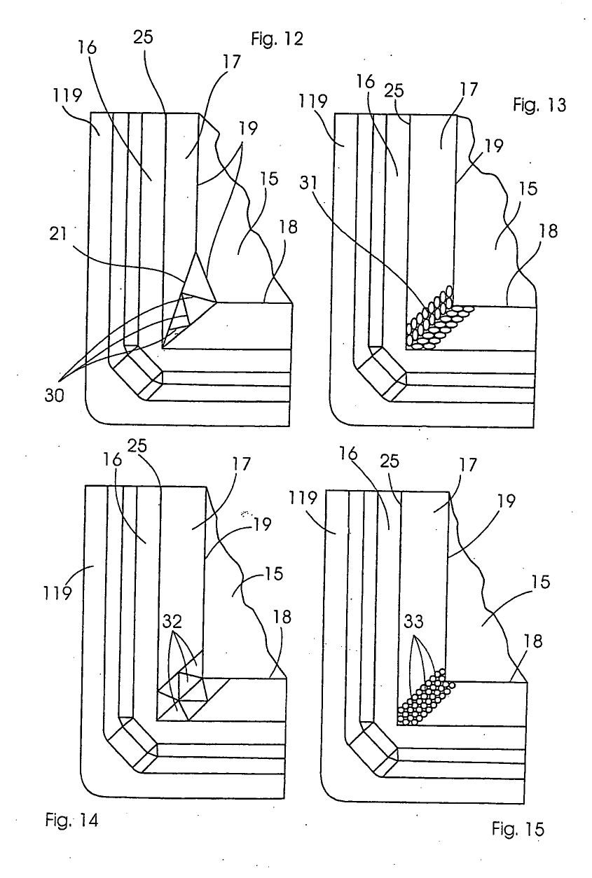

FIGS. 12, 13, 14 and 15 show alternatives of the triangular corner zones according to FIGS. 9 and 10;

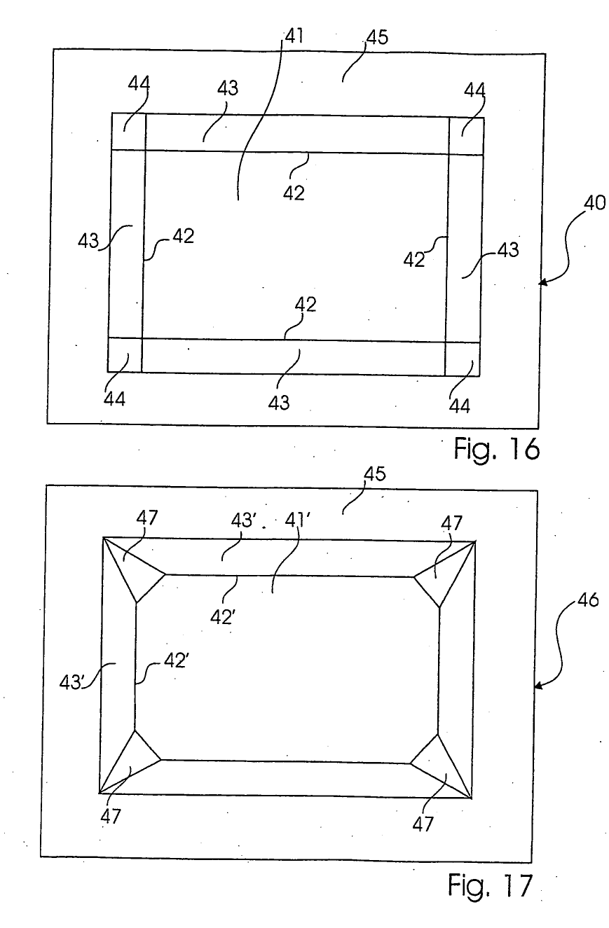

FIGS. 16, 17 and 18 show top views of receptacles with different patterns of hinge lines; and

FIG. 19, 20 and 21 show examples of different forms of coupling edges between the displaceable part and the rest of the bottom.

FIG. 1 shows a container 1 with four upright walls 2 and a bottom consisting of a flat bottom part 3, a flat central part 4 and a coupling edge part 5 connecting parts 3 and 4. FIG. 1 shows the bottom 3,4,5 in its basic form, in which it is for instance formed by an injection moulding machine.

FIG. 2 shows the situation where the container 1 is placed on the mouth 6 of a suction line 7, the suction device (not shown) connected thereto is energized, as indicated symbolically with arrow 8, and the central bottom part 4 is thereby displaced downward with temporary deformation of coupling edge 5 which is therefore designated 5′ in FIG. 2. In this situation of enlarged volume of the container, hot foodstuff is introduced into container 1 (not shown) and a lid 9 is arranged sealingly on mouth rim 10, for instance by sealing. The energizing of the suction device is then ended and the bottom takes on a shape which is determined by its mechanical properties and the pressure difference between the environment and the space in the closed container.

FIG. 3 shows this rest position of the filled container. It will be apparent that the flat central part 4 is suitable for allowing a surface to support the container 1 in stable manner.

FIG. 4 shows that the external air pressure as according to arrows 11 can result after a longer period of time in a certain pressure equalization occurring in the container as a consequence of the gas permeability of the material of the container, whereby the central part 4 will eventually take on its original basic form again. It is noted that the bottom will certainly assume this basic form when lid 10 is opened or removed. The invention therefore also has the feature of a guarantee seal.

FIGS. 5, 6, 7 and 8 show under the references (a), (b) and (c) the respective phases of supplying, filling with potatoes 41 and finally sealing (42) with a sealing foil 43 a container as according to four embodiments according to the invention.

In FIG. 5 a container is supplied with a downward extending bottom part 4 (FIG. 5a), it is then filled (FIG. 5b) and finally sealed (FIG. 5c). In the case of hot foodstuff there occurs due to condensation of water vapour a pressure decrease which brings the container into the state shown in FIG. 4. In the present case of potatoes, this change of shape takes place because the potatoes absorb carbon dioxide in the container. This gas forms or forms part of the protective atmosphere.

In the embodiment of FIG. 6 the central bottom part 4 is pressed downward (45) prior to filling by a mechanical pressing device 44 (FIG. 6a). A container 1 is then filled (FIG. 6b) and finally the container 1 is sealed (FIG. 6c).

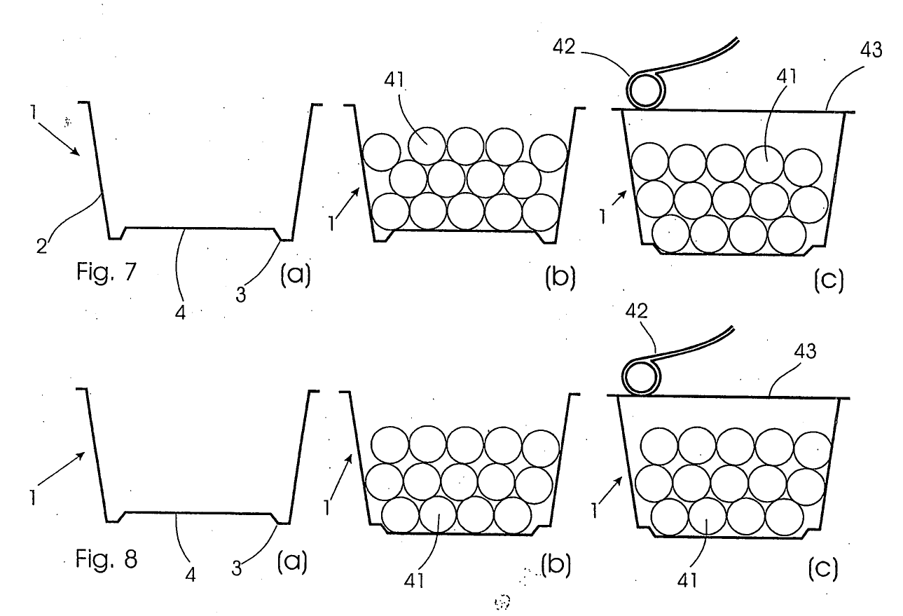

In the embodiment of FIG. 7 the container 1 initially has a form corresponding with FIG. 1. The filling takes place in this situation (FIG. 7b). Finally, the central bottom part 4 is displaced downward (FIG. 7c) as according to FIGS. 2 and 3, which can advantageously take place using a suction device, for instance by underpressure (FIG. 2), or a suction cup.

In the embodiment of FIG. 8 the container 1 is supplied as according to FIG. 7a, a displacement of the central bottom part 4 in downward direction then takes place either by a mechanical pressing or pressing by gas pressure or by suction, whereafter the thus formed container 1 is filled with foodstuff (FIG. 8b). In this situation the container is sealed (FIG. 8c).

Which of the four options is used in a particular process depends among other things on the foodstuff and the practical possibilities in a given process setup of making use of a mechanical pressing operation or of a suction head.

It is noted that FIG. 5, 6, 7, 8 are very schematic and only show symbolically the filled state of the container in respectively (a) and (b); (c).

Attention is finally drawn to the fact that it is considered impractical from a processing viewpoint to make use of a pressing element which must extend through food product to perform a pressing operation on the bottom part. Use will preferably be made for this purpose of external means, in particular suction means, which leave the foodstuff undisturbed.

FIGS. 9 and 10 show a receptacle 10 and a container 10 in the two described states.

Container 10 comprises four upright walls 11, 12, 13, 14 (see FIG. 9b), a bottom part 15 displaceable up and downward, a bottom peripheral edge 16 and a coupling edge 17 present between part 15 and edge 16. In respect of coupling edge 17 reference is now made to FIG. 9a, the top view of container 10. The movable upper part 15 is bounded by four hinge lines, all designated 18 for the sake of convenience. Situated in the corners are chamfered hinge lines 19, the ends of which are connected to respective hinge lines 20, 21. Hinge lines 19, 20 and 21 together form a triangle. The concurrence of hinge lines 20 and 21 occurs in the region of peripheral edge 16. A movable bottom part 15 is thus realized. It should be appreciated that the mobility is not such that the bottom part 15 could move up and downward in the manner of a piston. Such a variant will be discussed later with reference to FIG. 11. In the present embodiment, when a pressure difference occurs a local change of position can take place in the vicinity of a hinge line 19, in particular the zone where the construction is weakest. As soon as the movable bottom part 15 is displaced from the shown position at that location, the displacement will progress gradually along hinge lines 18, 19 until from the position shown in FIG. 9 the position shown in FIG. 10 has been reached, or vice versa.

The hinge lines can be embodied as corrugations or as weakened zones. For instance in the case of thermoforming or vacuum-forming corrugations are the most practical, while in the case of injection moulding there is the possibility of embodying the hinge lines as thinner wall zones.

On the top side of container 10 is situated a mouth 18 which is bounded by a mouth rim 119. This mouth rim is shown particularly clearly in FIG. 9b and 9c. It lies in a flat plane so that a filled container can be easily closed by a sealing foil, compare also FIG. 5c, 6c, 7c and 8c.

It will be apparent from FIGS. 9 and 10, and in particular sub-figures c, that a substantial volume change can be realized by displacing bottom part 15. This is a substantial advantage over the above described prior art.

FIG. 11 shows a detail of a container 20, of which the movable bottom part 21 connects to the bottom peripheral edge 22 via a rolling edge 23. FIG. 11b and 11c show schematically the manner in which, by rolling the rolling edge 23, the bottom part 21 is displaceable between the lower position shown in FIG. 11b and the upper position shown in FIG. 11c.

Rolling edge 23 must have a sufficient measure of mobility to allow the shown displacements. For this purpose the rolling edge can be embodied as a thinner wall part, be provided with a number of corrugations or can already have sufficient mobility naturally via fold lines 24, 25.

FIGS. 12, 13, 14 and 15 show alternatives to the triangular corner zones 19, 20, 21 according to FIGS. 9 and 10.

FIG. 12 shows an embodiment wherein additional lines 30 also extend between hinge lines 20 and 21. This improves the local mobility even further.

FIG. 13 shows an embodiment in which oval hinge lines 31 extend between the concurrence of hinge lines 18 and 19 and hinge line 25, which extends between coupling edge 17 and bottom peripheral edge 16. The oval figures are ordered in a pattern such that two rows have a main direction parallel to hinge line 18 and two rows correspond to the direction of hinge line 19.

FIG. 14 shows a variant wherein hinge lines generally designated 32 extend in a pattern of triangles.

Finally, FIG. 15 shows a variant of the embodiment according to FIG. 13 wherein use is made of substantially circular hinge lines 33 which are ordered in the drawn pattern.

FIG. 16 shows a receptacle 40 in top view. Receptacle 40 comprises a movable bottom part 41 with a generally rectangular form. Via all hinge lines designated 42 the movable part 41 is connected to coupling edge parts which have an elongate form and are all designated 43. The reference numeral 44 designates the corner zones of the coupling edge. The corner zones and coupling edge parts 43 are connected to the rest of the bottom 45. For the sake of clarity the details as shown in FIG. 12-15 relating to the four upright walls and the peripheral edge of the mouth opening are omitted.

It is of the greatest importance for the invention that the corner parts of coupling edge 43, 44 are wholly flexible. They can for instance have a relatively small wall thickness, but the hinge lines enclosing these corner parts can alternatively possess an extra flexibility, for instance be given a very thin form by pressing-in with an optionally heated stamp.

Owing to the thus obtained flexibility, the movable bottom part 41 can move easily between its downward displaced first position and its upward displaced second position.

FIG. 17 shows a receptacle 46, of which the displaceable bottom part 41′ is enclosed by a coupling edge consisting of elongate parts 43′ and corner parts 47 with a generally triangular form. It is also the case for this embodiment that corner parts 47 are flexible. They are preferably directed upward in slightly convex manner and as the one extreme position of movable part 41′ transposes to the other extreme position a clicking takes place which, as in all embodiments, begins in one of the corners and, after yielding thereof, is followed by yielding of the other corners, so that the subsequent position is reached after clicking in the corners four times.

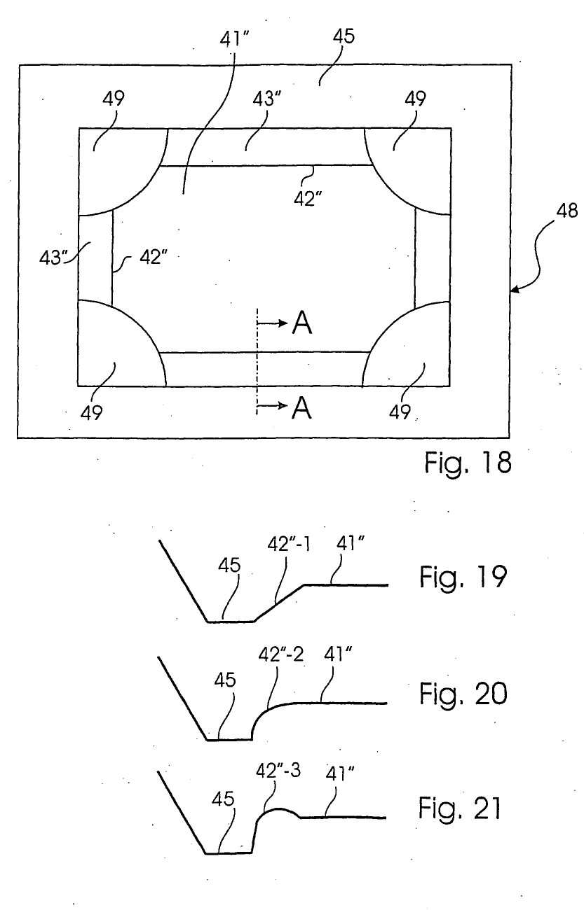

FIG. 18 shows a receptacle 48 with a movable bottom part 41″. The elongate coupling edge parts are designated 43″ in this embodiment and the hinge lines between these parts and the movable bottom part 41″ are designated 42″, while those in FIG. 17 are designated 42′.

In this embodiment the corner parts 49 of the coupling edge each take the form of a quarter-circle. They are also flexible in this embodiment and enable an easy displacement of the movable bottom part 41′ from the one position to the other.

FIGS. 19, 20 and 21 show respective possible cross-sections at the position A-A in FIG. 18 or any other suitable embodiment. In all three drawn configurations the bottom part is situated in its upward displaced position. The coupling edges are designated respectively with 42″-1, 42″-2 and 42″-3.

It will be apparent from these three figures that the coupling edge can take diverse appropriate forms.

It is essential in all conditions that the configuration of the receptacle allows a good mobility of the movable bottom part, and that the pressure differences which occur never result in any externally discernible deformation which may give a user the impression that the receptacle is of a poor quality type.

All drawn and described embodiments have in common that they enable an easy mobility of the movable bottom part, particularly in the region of the four corner zones.

Attention is drawn to the fact that the drawn and described embodiments relate only to a displaceable part acting as displacer which is incorporated in the bottom of the packaging. It will however be apparent that this displacer part can be embodied in the same manner, then forming part of an upright wall part which in turn forms part of the body, or forming part of the lid.

1. Packaging for foodstuffs to be offered for sale, comprising:
an integral receptacle having on its top side a mouth opening and on its underside a bottom with an upright body connecting thereto and having at least one flat body part;
which mouth opening is bounded by a mouth rim which lies substantially in a flat plane and which, after filling of the receptacle with foodstuff and optionally a chosen gas or gas mixture, can co-act in hermetically sealing manner with a lid, for instance a foil connected by sealing to the mouth rim;
a generally flat displaceable part which forms part of the bottom, the body part or the lid and acts as displacer, which part is connected to the remaining peripheral part of respectively the bottom, the body part or the lid by an at least one-dimensionally elastically deformable coupling edge; and
optionally a filling with a gas serving as protective atmosphere, for instance a mixture of CO₂ and N₂ or CO₂ and O₂;
characterized in that
the displaceable part has a generally rectangular shape corresponding with the shape of said remaining part of the bottom, the body or the lid;
the surface area of the displaceable part amounts to at least 50% of the total surface area of the bottom, the body or the lid;
the displaceable part substantially has bending stiffness;
an elastically deformable zone is situated in each of the four corner zones of the coupling edge and over the whole periphery of the displaceable part;
this such that the displaceable part is movable between a first position displaced to the outside and a second position displaced to the inside.

2. Packaging as claimed in claim 1,
characterized in that
the displaceable part is situated in the bottom and that in the first position the receptacle can rest on the displaceable part of the bottom and in the second position can rest on the bottom edge.

3. Packaging as claimed in claim 1,
characterized in that
the deformable zone consists at least in said corner zones of at least two hinge lines.

4. Packaging as claimed in claim 1,
characterized in that
the deformable zone comprises a rolling zone.

5. Packaging as claimed in claim 3,
characterized in that
the hinge lines are corrugations protruding out of the local main plane of the receptacle.

6. Packaging as claimed in claim 3,
characterized in that
the hinge lines are zones with reduced thicknesses.

7. Packaging as claimed in claim 1,
characterized in that
the receptacle consists of plastic.

8. Packaging as claimed in claim 3,
characterized in that
the receptacle is manufactured by thermoforming or vacuum-forming, for instance from a laminate.

9. Packaging as claimed in claim 3,
characterized in that
the receptacle is manufactured by injection moulding.

10. Packaging as claimed in claim 1,
characterized in that
both the first position and the second position of the displaceable part are stable, and the configuration thus possesses a bistable character.

11. Packaging as claimed in claim 1,
characterized in that
the receptacle consists substantially of foam material.

12. Packaging as claimed in claim 8,
characterized in that
the receptacle is formed from a strip of foam material.

13. Packaging as claimed in claim 12,
characterized in that
the strip of foam material is manufactured by extrusion and optional sizing.

14. Packaging as claimed in claim 13,
characterized in that
by a laminating operation following the extrusion there is arranged on at least one side a foil layer, for instance an oxygen-barrier foil.

15. Packaging as claimed in claim 12,
characterized in that
the strip of foam material is not fully foamed and that by supplying heat to the mould cavity of a die an additional foaming occurs, whereby a desired, for instance uniform wall thickness can be obtained.

16. Packaging as claimed in claim 6,
characterized in that
the hinge lines are formed by ribs present in the mould cavities of a die.

17. Packaging as claimed in claim 16,
characterized in that
the ribs are situated on a releasable insert which has to be positioned in the mould cavity of the die.

18. Packaging as claimed in claim 11,
characterized in that
the hinge lines are formed by pressing against a formed receptacle an optionally heated stamp having ribs corresponding with the hinge lines.

19. Packaging as claimed in claim 1,
characterized in that
the receptacle is formed from a blank consisting substantially of cardboard.

20. Packaging as claimed in claim 19,
characterized in that
the blank is provided with a foil, for instance an oxygen-barrier foil, on at least the side of the blank later forming the inside of the receptacle.

21. Packaging as claimed in claim 19,
characterized in that
the receptacle is formed from the blank by a mould with a forming surface and corresponding stamp.

22. Packaging as claimed in claim 19,
characterized in that
the receptacle is formed by first removing the four corner zones from the blank and subsequently folding the walls upward and adhering these walls sealingly to each other in mutually overlapping relation.

23. Packaging as claimed in claims 20 and 22,
characterized in that
the blank is provided on both sides with a foil, and the sealing adhesion is brought about by a welding operation.

24. Packaging as claimed in claim 19,
characterized in that
the receptacle is formed by placing a paper fibre pulp in a mould cavity corresponding with the receptacle and causing it to dry, optionally under pressure and/or with heating.

25. Packaging as claimed in claim 1,
characterized in that
the receptacle consists of aluminium, for instance with a thickness in the order of magnitude of 60 μm.

26. Packaging as claimed in claim 1,
characterized in that
the packaging is intended for potatoes and/or fish or products based thereon, that the gas mixture contains CO₂ and N₂ and that the ratio of these gas components amounts to 70:30, preferably 80:20 and still more preferably 90:10.

27. Packaging as claimed in claim 1,
characterized in that
the packaging is intended for meat or products based thereon, that the gas mixture contains CO₂ and O₂ and that the ratio of these components is chosen to achieve an optimum in respect of discolouration of the packed foodstuff and the shelf life.

28. Packaging as claimed in claim 1,
characterized in that
the packaging is intended for frozen goods, for instance ice cream or deep-frozen products, wherein the protective atmosphere is absent and wherein after removal of the lid the frozen product can be released from the receptacle by pressing the displaceable part inward.
